(19) United States
(12) Patent Application Publication
(10) Pub. No.: US 2026/0245086 A1
(43) Pub. Date: Aug. 20, 2026

(54) SYSTEMS AND METHODS FOR PAYMENT USING LINKED ASSETS

(71) Applicant: Wells Fargo Bank, N.A., San Francisco, CA (US)

(72) Inventors: Alexander Lyudin, New York, NY (US); Alexander Wittkowski, San Francisco, CA (US)

(21) Appl. No.: 19/056,672

(22) Filed: Feb. 18, 2025

(51) Int. Cl. G06Q 20/40; G06Q 20/10; G06Q 20/38; G06Q 20/42

(52) U.S. Cl. CPC G06Q 20/401; G06Q 20/108; G06Q 20/382; G06Q 20/42

(57) ABSTRACT

Systems and methods are disclosed herein for paying by a linked account. An example method includes initiating a transaction comprising a cash value, where the transaction involves a merchant service provider, and retrieving, from a digital wallet, a first data object including transaction details and an indication of a linked account. The example method also includes sending a transaction request including the cash value, an indication of the merchant service provider, and a transaction detail, and receiving a first payment token including an indication of the linked account and approval of the transaction by the linked account. The example method also includes modifying the first payment token to produce a second payment token, transmitting the second payment token to the merchant service provider, receiving a response message generated by the merchant service provider, and causing display of a message indicating the successful transaction.

### BACKGROUND

Electronic payments systems may facilitate the transfer of funds digitally without the need for physical cash. Such systems may include card payments, online payments, mobile transactions, and the like. A range of technologies including near field communication (NFC), secure web gateways have become integral to commerce, supporting a wide variety of purchases and other transactions.

### BRIEF SUMMARY

Financial services industries have long been centered around a relationship where a single customer accesses accounts for which they are listed as owners. Many people manage finances as part of a household (e.g., two incomes, expenses shared by families or roommate groups, etc.). Technologies are needed to shift the practice of financial services industries to more closely follow the way customers use these services. For example, various embodiments disclosed herein may enable two or more people to share view access for accounts, transactions, or other pages, thus facilitating the way finances are managed in the real world.

Furthermore, by enabling clients to invite a non-client to view and/or interact with their information through a bank or other financial service, such services may be spread to unbanked persons, improving financial stability for customers and growing the customer base for the financial service. Example embodiments disclosed herein thus pose an opportunity to grow the reach of financial services while providing benefits to customers first and foremost.

Example embodiments disclosed herein transform the traditional financial services model by embedding a social layer into financial mobile applications. Such features may encourage customers to interact with family and friends, fostering a collaborative environment that may extend beyond individual client relationships.

Example embodiments may enable customers to invite family members and friends to collaborate in their interactions with financial services using a mobile application or other interfaces. Traditionally, such interfaces and interactions are isolated, with each family member managing finances independently. Example embodiments break down these siloed interactions, creating a more interconnected and supportive financial ecosystem.

Furthermore, example systems and methods disclosed herein enable an array of social interactions and connections particularly related to financial services. For example the financial services mobile application may facilitate messaging and group chats that allow users of linked accounts to discuss and approve investment decisions in real-time, including the use of specialized user interfaces for collaborative decision-making. In another example, a user of a first account may request approval to pay a bill from a linked account (for example, the linked account may be a parent or guardian), and the linked account may approve and execute the payment through the financial services mobile application. Users may also share or replicate investment strategies with trusted contacts, promoting a collaborative financial community.

Accordingly, the present disclosure sets forth systems, methods, and apparatuses for payment using linked assets. In an example method, a first device associated with a first account may initiate a transaction with a merchant service provider for a particular cash value. The first device may retrieve a payment method from a digital wallet, which may include transaction details and a link to a second linked account, from which the funding is to be requested. The first device may send a transaction request to a payment server, and the transaction request may include details such as the cash value of the transaction, identification of a merchant service provider, and various details of the transaction, such as a short text description. The payment server may interact with the second device (associated with a second account linked to the first account) to prepare a payment token with authorization of the user of the linked account. The server may then transmit the payment token to the first device, which may receive the payment token and perform one or more modifications, such as encapsulating or further encrypting the payment token. The payment token may then be transmitted to the merchant service provider, for example, via a web portal for online shopping, or using NFC for in-person transactions. The merchant device may then verify the validity of the payment token and perform settlement of the transaction with the server device using the transaction details found in the payment token. The server and/or the merchant service provider may then provide a response message to the first device and the second device, indicating the success or failure of the transaction, and the settlement of the transaction may be performed using funds from the linked account.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for transactions using shared assets, in accordance with some example embodiments described herein.

FIG. 2 illustrates a schematic block diagram of example circuitry embodying a client device, in the context of a linked account payment system, that may perform various operations in accordance with some example embodiments described herein.

FIG. 3 illustrates another schematic block diagram of example circuitry embodying a linked account payment system that may perform various operations in accordance with some example embodiments described herein.

FIG. 4 illustrates an example flowchart for transactions using shared assets, in accordance with some example embodiments described herein.

FIG. 5 illustrates another example flowchart for transactions using shared assets via NFC, in accordance with some example embodiments described herein.

FIG. 6 illustrates another example flowchart for transactions using shared assets, in accordance with some example embodiments described herein.

FIG. 7 illustrates a swim lane diagram with example operations that may be performed by components of the environment depicted in FIG. 1, in accordance with some example embodiments described herein.

FIG. 8 illustrates another swim lane diagram with example operations that may be performed by components of the environment depicted in FIG. 1, in accordance with some example embodiments described herein.

FIG. 9 illustrates an example user interface used in some example embodiments described herein.

FIG. 10 illustrates another example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

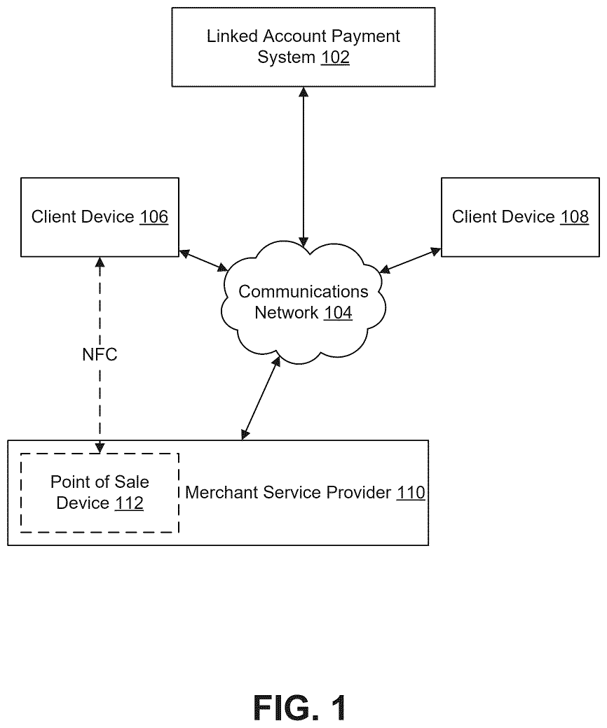

Example embodiments described herein may be implemented using any of a variety of computing devices or servers. To this end, FIG. 1 illustrates an example environment within which various embodiments may operate. As illustrated, a linked account payment system 102 may receive and/or transmit information via communications network 104 (e.g., the Internet) with any number of other devices, such as client device 106, client device 108, and/or merchant service provider 110 (including, optionally, a point of sale device 112).

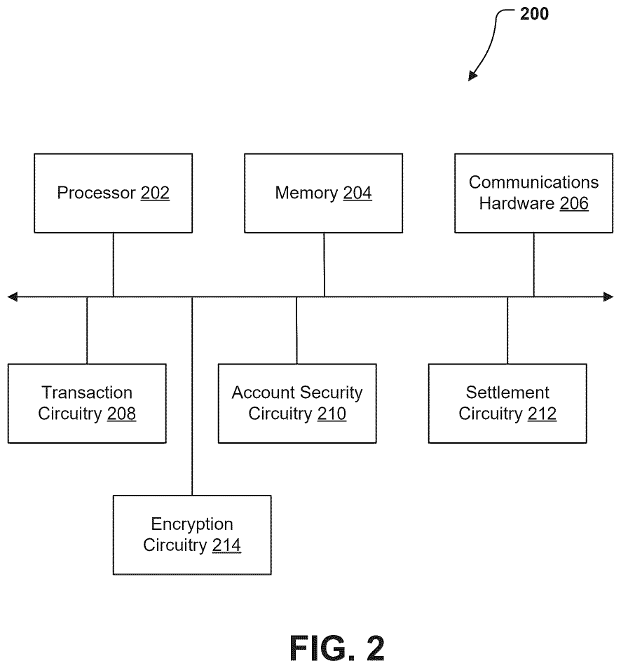

The linked account payment system 102 may be implemented as one or more computing devices or servers, which may be composed of a series of components. Particular components of the linked account payment system 102 are described in greater detail below with reference to apparatus 200 in connection with FIG. 2.

The client device 106 and/or client device 108 may be embodied by any computing devices known in the art. The client device 106 and client device 108 need not be independent devices but may be embodied as one or more peripheral devices communicatively coupled to other computing devices. In some examples, a device capable of interacting via communications network 104 with linked account payment system 102 may load software and/or other data to provide capabilities of client device 106 and/or client device 108. For example, a user may begin a transaction with linked account payment system 102 using a mobile phone or tablet, pause the interaction, and continue the interaction using a desktop computer via a web portal with the same linked account payment system 102.

The merchant service provider 110 may be embodied by any computing device, cloud system, or other collection of devices known in the art. The merchant service provider may be a web server or collection of web-hosted services, in the context of online commerce, and/or may also include a point of sale device 112 for in-person interactions (which may also interact with one or more web servers or other cloud services). The point of sale device 112 may be capable of direct communication with one or more of client device 106 and/or client device 108 using near field communication (NFC) or other technologies, with or without the use of communications network 104.

### Example Implementing Apparatuses

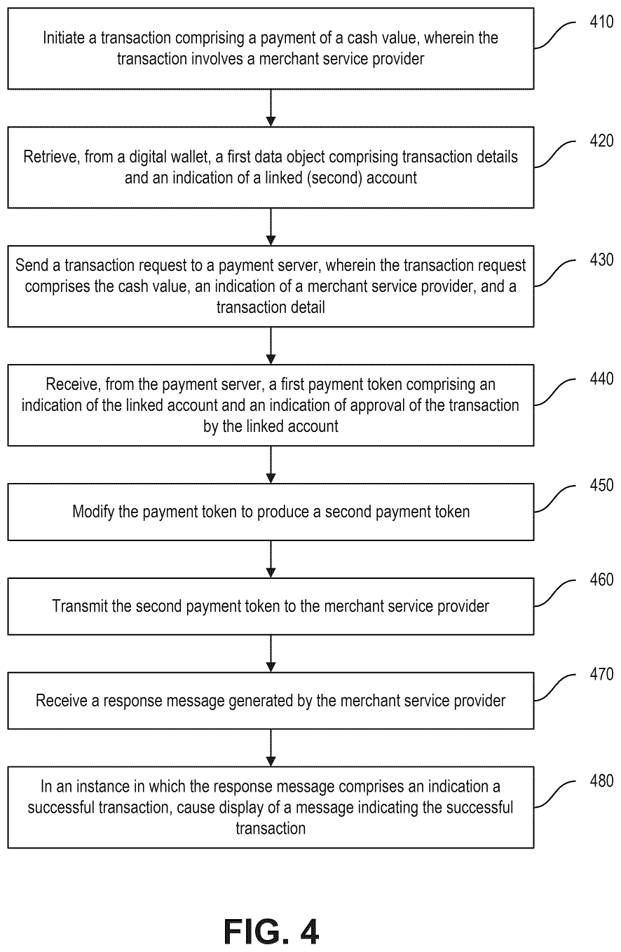

The linked account payment system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-7. As illustrated in FIG. 2, the apparatus 200 may include processor 202, memory 204, communications hardware 206, transaction circuitry 208, account security circuitry 210, settlement circuitry 212, and encryption circuitry 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a transaction circuitry 208 that processes transaction details and generates or encapsulates payment tokens. The transaction circuitry 208 may utilize processor 202, memory 204, or any other hardware component included in the apparatus 200 to perform these operations, as described in connection with FIGS. 4-7 below. The transaction circuitry 208 may further utilize communications hardware 206 to gather data from a variety of sources (e.g., client device 106 and client device 108, shown in FIG. 1), and/or exchange data with a user, and in some embodiments may utilize processor 202 and/or memory 204 to process payments and other transactions.

In addition, the apparatus 200 further comprises an account security circuitry 210 that verifies validity of the transaction request based on the first account. The account security circuitry 210 may utilize processor 202, memory 204, or any other hardware component included in the apparatus 200 to perform these operations, as described in connection with FIGS. 4-7 below. The account security circuitry 210 may further utilize communications hardware 206 to gather data from a variety of sources (e.g., client device 106 and client device 108, shown in FIG. 1), and/or exchange data with a user, and in some embodiments may utilize processor 202 and/or memory 204 to verify accounts.

In addition, the apparatus 200 further comprises a settlement circuitry 212 that performs settlement of financial transactions. The settlement circuitry 212 may utilize processor 202, memory 204, or any other hardware component included in the apparatus 200 to perform these operations, as described in connection with FIGS. 4-7 below. The settlement circuitry 212 may further utilize communications hardware 206 to gather data from a variety of sources (e.g., client device 106 and client device 108, shown in FIG. 1), and/or exchange data with a user, and in some embodiments may utilize processor 202 and/or memory 204 to settle transactions.

In addition, the apparatus 200 further comprises an encryption circuitry 214 that encrypt and decrypt data or perform other cryptographic operations. The encryption circuitry 214 may utilize processor 202, memory 204, or any other hardware component included in the apparatus 200 to perform these operations, as described in connection with FIGS. 4-7 below.

The encryption circuitry 214 may further utilize communications hardware 206 to gather data from a variety of sources (e.g., client device 106 and client device 108, shown in FIG. 1), and/or exchange data with a user, and in some embodiments may utilize processor 202 and/or memory 204 to perform cryptographic operations.

Although components 202-214 are described in part using functional language, it will be understood that the particular implementations necessarily include the use of particular hardware. It should also be understood that certain of these components 202-214 may include similar or common hardware. For example, the transaction circuitry 208, account security circuitry 210, settlement circuitry 212, and encryption circuitry 214, may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. While the term “circuitry” should be understood broadly to include hardware, in some embodiments, the term “circuitry” may in addition refer to software instructions that configure the hardware components of the apparatus 200 to perform the various functions described herein.

Although the transaction circuitry 208 may leverage processor 202, memory 204, or communications hardware 206 as described above, it will be understood that any of transaction circuitry 208, account security circuitry 210, settlement circuitry 212, and encryption circuitry 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that transaction circuitry 208, account security circuitry 210, settlement circuitry 212, and encryption circuitry 214 comprise particular machinery designed for performing the functions described herein in connection with such elements of apparatus 200.

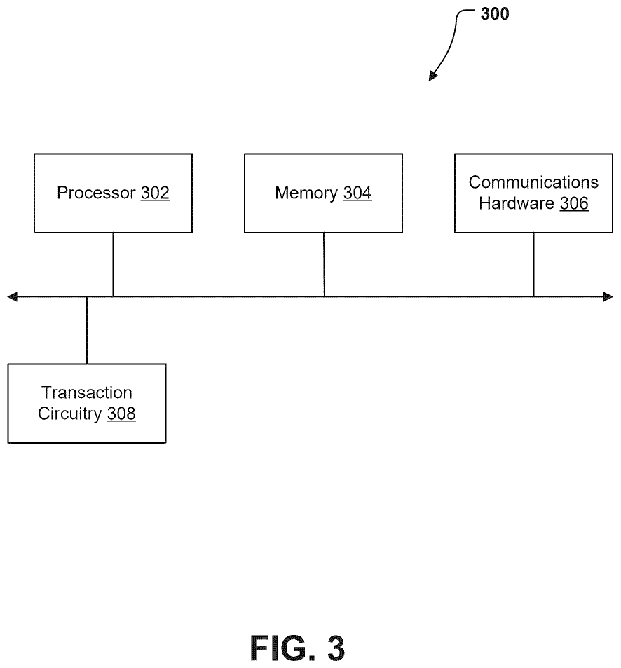

As illustrated in FIG. 3, an apparatus 300 is shown that represents an example client device (e.g., any of client device 106 or client device 108). The apparatus 300 includes processing circuitry 302, memory 304, and communications hardware 306, and transaction circuitry 308, each of which is configured to be similar to the similarly named components described above in connection with FIG. 2.

In some embodiments, various components of the apparatuses 200 and 300 may be hosted remotely (e.g., by one or more cloud servers) and thus need not physically reside on the apparatus 200 or apparatus 300. For instance, some components of the apparatus 200 or apparatus 300 may not be physically proximate to the other components of apparatus 200 or apparatus 300. Similarly, some or all of the functionality described herein may be provided by third party circuitry. For example, a given apparatus 200 or apparatus 300 may access one or more third party circuitries in place of local circuitries for performing certain functions.

As will be appreciated based on this disclosure, example embodiments contemplated herein may be implemented by an apparatus 200 or apparatus 300. Furthermore, some example embodiments may take the form of a computer program product comprising software instructions stored on at least one non-transitory computer-readable storage medium (e.g., memory 204 or memory 304). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 or apparatus 300 as described in FIGS. 2-3, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Operations

Turning to FIGS. 4, 5, and 6, example flowcharts are illustrated that contain example operations implemented by example embodiments described herein. The operations illustrated in FIGS. 3-5 may, for example, be performed by the linked account payment system 102, client device 106, client device 108, and/or merchant service provider 110 shown in FIG. 1, which may in turn be embodied by an apparatus 200 and/or apparatus 300, which are shown and described in connection with FIGS. 2-3. To perform the operations described below, the apparatus 200 and apparatus 300 may utilize one or more of processor 202, memory 204, communications hardware 206, transaction circuitry 208, account security circuitry 210, settlement circuitry 212, encryption circuitry, processor 302, memory 304, communications hardware 306, transaction circuitry 308, and/or any combination thereof. It will be understood that user interaction with the apparatus 200 or apparatus 300 may occur directly via communications hardware 206 communications hardware 306 or may instead be facilitated by a separate client device 106 or client device 108, as shown in FIG. 1, and which may have similar or equivalent physical componentry facilitating such user interaction.

Turning first to FIG. 4, example operations are shown for transactions using shared assets using a client device 106. As shown by operation 410, the apparatus 300 includes means, such as processor 302, memory 304, communications hardware 306, or the like, for initiating a transaction comprising a cash value and involving a merchant service provider 110. In some examples, the transaction may be initiated in the context of online shopping, such as using a website or internet shopping portal such as a mobile application. In such examples, initiating the transaction may involve a user filling an online shopping cart and finalizing the contents of the purchase to check out and begin payment. The apparatus 300 may display a user interface for online shopping in accordance with the shopping interface provided by merchant service provider 110. The merchant service provider 110 may provide an interface for the communications hardware 306 to provide details such as a shipping address, contact information, and transaction details. The merchant service provider 110 may also finalize the details of the transaction such as shipping costs, taxes, and/or the like, to produce a final monetary value or cash value of the transaction.

In another example, the merchant service provider 110 may use a physical point of sale device 112. In such examples, initiating the transaction may include scanning or otherwise identifying the items involved in the transaction, and totaling the costs including taxes and/or other fees. The apparatus 300 may interact with the point of sale device 112 via NFC capabilities of communications hardware 306, other wireless communication capabilities, or by scanning information such as a QR code to facilitate lookup of transaction details using other network communications.

In some embodiments, the communications hardware 306 may receive an indication of the linked account via a chat user interface (UI). For example, sending a transaction request to a client device 108 associated with the linked account may cause an indication of the transaction request to be displayed on the second device using a second chat UI, which may mirror the chat UI of the client device 106. In such examples, the chat UI may be used to establish the link between the two accounts, to create a pre-approval for the transaction, or to provide advance notice of the transaction so that the user of the client device 108 may be ready and waiting to receive the real-time transaction approval request.

As shown by operation 420, the apparatus 300 includes means, such as transaction circuitry 308, or the like, for retrieving, from a digital wallet, a first data object comprising transaction details and an indication of a linked account. For example, the transaction circuitry 308 of the apparatus 300 may include a mobile application that acts as a digital wallet, or may include data belonging to an existing mobile wallet application. In some embodiments, the transaction circuitry 308 may provide a payment method in the digital wallet that may appear alongside traditional payment methods (e.g., credit cards, debit cards, and/or the like). The payment method may indicate the linked account (e.g., associated with client device 108) which has provided prior authorization to link to the account associated with client device 106. The payment method, for example, may have an illustrative name indicating that the payment method request funds from another account, such as “purchases for book club” or “request payment by parents.” The payment method may seamlessly be selected and provided in the context of a payment situation for online shopping or in-person payment using a mobile device. In some embodiments, the payment method may appear only when a prior authorization has been provided using a mobile application associated with the financial services provider associated with the payment method (e.g., a payment server). For example, the linked account associated with client device 108 may receive a notification requesting authorization for linked account payments within the mobile application. By replying affirmatively to the request, the payment method associated with the linked account may appear in the digital wallet of the user of client device 106.

In some embodiments, the transaction circuitry 308 may retrieve transaction details from the merchant service provider 110. In embodiments in which the transaction occurs via a web-based transaction portal, an online transaction portal, online purchase interface, or any other web-based transaction method, the transaction circuitry 308 may be configured to retrieve the transaction details from the web page. The transaction details may be retrieved via an API, by scraping the information from the raw data of the web portal, or using any other means known in the art. In some embodiments, the transaction circuitry 308 may use an artificial intelligence model (e.g., a language model or the like) to process the web portal as input and determine transaction details including the identity of the merchant service provider, the nature of the transaction, the items being purchased or otherwise involved in the transaction, and/or the like.

In some examples, the account associated with client device 106 may be a “thin account” meaning that it may be an account without a full range of services provided by a financial services provider. Accordingly, the thin account may be linked to a standard account (a primary account) from which funds may be requested. Such a configuration may be helpful for children with gated access to funds of a parent's account, for officers of an organization or club with conditional approval to make purchases for the organization, and/or the like. The thin account may, for example, not be associated with its own line of credit, checking or savings account, or the like, but may still be capable of utilizing various financial services. The thin account may identify the user associated with the account in accordance with any regulatory requirements, such as “know your customer” (KYC) requirements.

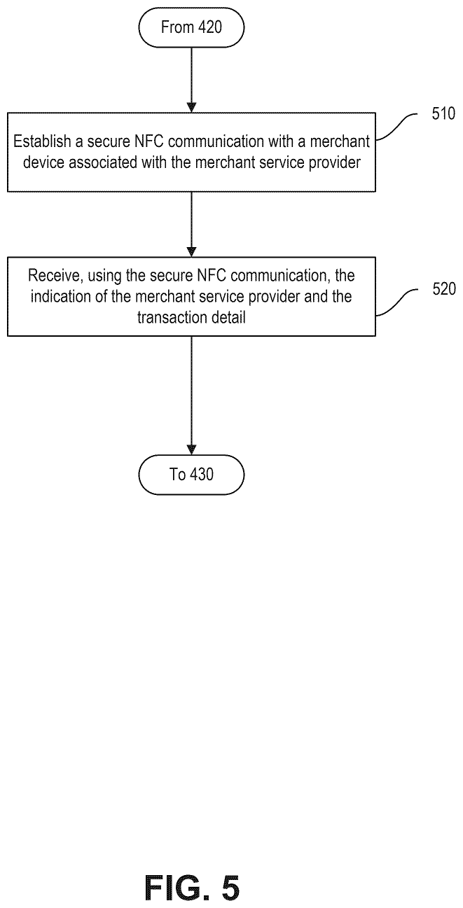

Turning now to FIG. 5, as shown by operation 510, the apparatus 300 includes means, such as communications hardware 306, or the like, for establishing a secure NFC communication with a merchant device associated with the merchant service provider 110. The communications hardware 306 may use any protocols known in the art for establishing the secure NFC communication. For example, the communications hardware 306 may first initiate a communication by performing a handshake operation. The handshake operation may include exchanging hardware identifier information, capabilities of each device, and/or other information relevant to establishing the secure NFC communication. The communications hardware 306 may subsequently perform authentication, for example, using an established public key infrastructure, certificates, and/or the like to establish that devices are communicating with trusted entities. The communication hardware 306 may further perform encryption using an agreed-upon encryption method, which may also use an established public key infrastructure. Data may then be physically transmitted between the devices using NFC technology, and the session may be terminated thereafter.

As shown by operation 520, the apparatus 300 includes means, such as communications hardware 306, or the like, for receiving the indication of the merchant service provider 110 and the transaction detail using the secure NFC communication. For example, the merchant service provider 110 may be identified during a handshake operation, or such information may be provided as an encrypted data transmission after establishing the connection. In some embodiments, the transaction detail may also be communicated using secure communication and received using the communications hardware 306. In some embodiments, the payment token or other transaction details may not be provided by the apparatus 300 at this time, and the communications hardware 306 may instead gather information for the purposes of making a request to a payment server for authorizing the transaction using the linked account (second account).

Returning to FIG. 4, as shown by operation 430, the apparatus 300 includes means, such as communications hardware 306, or the like, for sending a transaction request to a payment server. The transaction request may comprise the cash value, an indication of a merchant service provider 110, and a transaction detail. The communications hardware 306 may utilize an application programming interface (API) to submit the transaction request, which may provide an interface for entering the cash value, the indication of the merchant service provider 110, and one or more transaction details. The transaction details may include a short text description of the transaction, an itemized list of items to be purchased, a date and time of the transaction, and/or any other information related to the transaction.

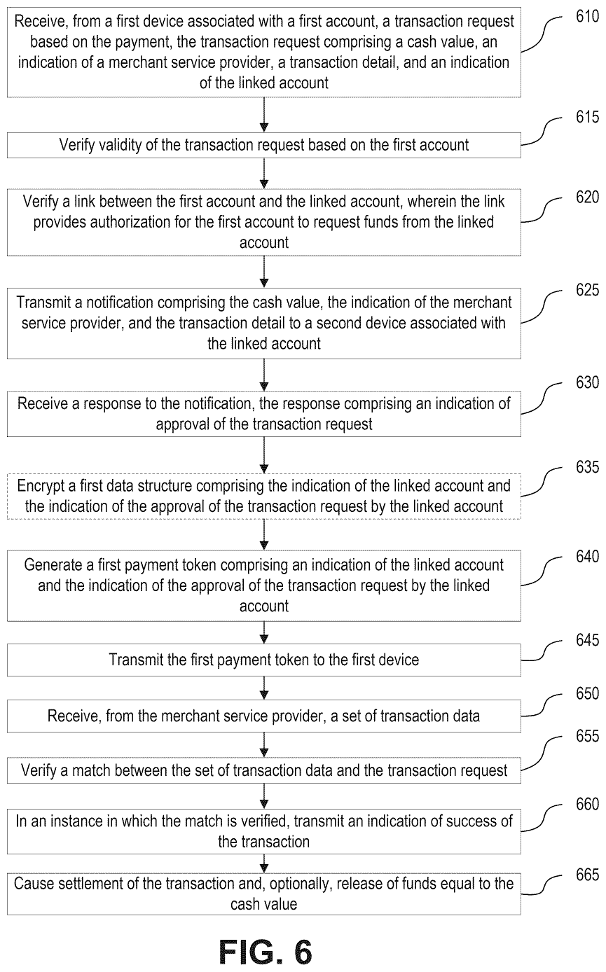

As shown by operation 440, the apparatus 300 includes means, such as communications hardware 306, or the like, for receiving, by the communication hardware and from the payment server, a first payment token comprising an indication of the linked account and an indication of approval of the transaction by the linked account. The generation of the payment token is described below in connection with FIG. 6, including at least operation 610, operation 615, operation 620, and operation 625. For example, after initiating the transaction and selecting the payment method from a digital wallet, the communications hardware 306 may automatically send the request to the payment server, which may request real-time permission from the holder of client device 108 (associated with the linked account), and upon receiving approval, provide the first payment token to the client device 106. The first payment token may include transaction details that enable a merchant service provider 110 to settle a transaction using funding associated with the linked account. For example, in some embodiments the first payment token may be or may comprise a payment card number (e.g., a credit card number or debit card number). Accordingly, the payment card number may be generated on-the-fly for the particular transaction and may transparently be passed to the merchant service provider 110 for completion of the transaction.

As shown by operation 450, the apparatus 300 includes means, such as transaction circuitry 308, or the like, for modifying the payment token to produce a second payment token. In some embodiments, the transaction circuitry 308 may modify the payment token by encapsulating, encrypting, or performing other modifications. For example, the transaction circuitry 308 may receive information from the merchant service provider 110 and/or point of sale device 112 specifying a particular format or encapsulation to apply to the payment token for the payment token to be considered valid. The transaction circuitry 308 may apply any modifications to the payment token required to submit a valid payment token using any form of transmission known in the art.

As shown by operation 460, the apparatus 300 includes means, such as communications hardware 306, or the like, for transmitting the second payment token to the merchant device (e.g., associated with a merchant service provider 110). The communications hardware 306 may use, for example, a web interface, an NFC communication, or other means to transmit the second payment token to the merchant service provider 110.

As shown by operation 470, the apparatus 300 includes means, such as communications hardware 306 or the like, for receiving a response message generated by the merchant service provider 110. The communications hardware 306 may receive the response message from the payment server in addition to the confirmation from the merchant service provider 110 (which may be physically transmitted through a merchant device such as a point of sale device 112). For example, a web server of the merchant service provider 110 may provide a confirmation web page displaying details of the transaction, a receipt number, delivery details, and/or other information related to the completed transaction.

As shown by operation 480, the apparatus 300 includes means, such as communications hardware 306, or the like, for in an instance in which the response message comprises an indication a successful transaction, causing display of a message indicating the successful transaction. For example, the communications hardware 306 may display a confirmation web page, a push notification of a mobile application, and/or the like, for confirming the successful transaction. In an instance in which the transaction is not successful, the communications hardware 306 may also display a notification to that effect, and may additionally provide a reason for the failure of the transaction.

FIG. 6 is a flowchart of an example method for performing a transaction using shared assets via a server device. As shown by operation 610, the apparatus 200 includes means, such as communications hardware 206, or the like, for receiving, from a first device (e.g., client device 106) associated with a first account, a transaction request comprising a cash value, an indication of a merchant service provider, a transaction detail, and an indication of the linked account. The transaction request may be based on the payment or other transaction described in connection with FIGS. 4-5. The communications hardware 206 may utilize an API to receive the transaction request, which may provide an interface for entering the cash value, the indication of the merchant service provider 110, and one or more transaction details. The transaction details may include a short text description of the transaction, an itemized list of items to be purchased, a date and time of the transaction, and/or any other information related to the transaction.

As shown by operation 615, the apparatus 200 includes means, such as account security circuitry 210, or the like, for verifying validity of the transaction request based on the first account. For example, the account security circuitry 210 may request a session token from the client device 106 indicating that the transaction request is provided as part of a secure session. In some embodiments, the first account may be authenticated using password authentication, one-time password authentication, biometric authentication, and/or the like. For an authenticated account, the account security circuitry 210 may check that the account is authorized to perform linked transactions. For example, the first account may be a thin account (as described previously) which may have authorization to perform requests for linked account transactions under certain circumstances. Accordingly, the account security circuitry 210 may check that the transaction request conforms with requirements for authorization, for instance, checking that the transaction details match the authenticated account.

As shown by operation 620, the apparatus 200 includes means, such as account security circuitry 210, or the like, for verifying, by the account security circuitry, a link between the first account and the linked account. The link may provide authorization for the first account to request funds from the linked account. For example, the first account may have a pre-existing link, existing as a data entry in an account database, linking the first account to the second account (the linked account). The link may be established by a prior interaction with the payment server, causing modification of an account entry in the account database. The account security circuitry 210 may verify that such a link exists, that the link includes the first account and the linked account, and that the link authorizes transactions of the type corresponding to the present transaction being considered. In the event that the link does not exist or does not authorize the present transaction, the apparatus 200 may interrupt the transaction and provide an indication to the client device 106 that the transaction is declined.

As shown by operation 625, the apparatus 200 includes means, such as communications hardware 206, or the like, for transmitting a notification comprising the cash value, the indication of the merchant service provider 110, and the transaction detail to a second device associated with the linked account. The notification may be transmitted via an API, providing the required details which may include the cash value of the transaction, an identity of the merchant service provider 110, and one or more transaction details. The notification may cause the second device to display a notification via a user interface of the client device 108. The notification may request a response approving or rejecting the transaction. For example, the client device 108 may display a push notification with text indicating “Account A is requesting approval for $X to purchase Textbook B at Vendor C”, which may be accompanied by interface buttons for approving or denying the request. Accordingly, the approval may be performed rapidly and reduce delay in the checkout process for the requesting user of client device 106.

As shown by operation 630, the apparatus 200 includes means, such as communications hardware 206, or the like, for receiving a response to the notification comprising an indication of approval of the transaction request. Upon indicating approval or denial of the request, the client device 108 may respond to the apparatus 200 (e.g., a payment server) with response corresponding to the user's indication. The approve or deny message may also be transmitted and received via an API of the apparatus 200 and client device 108.

As shown by operation 635, the apparatus 200 may include means, such as encryption circuitry 214, or the like, for encrypting a first data structure comprising the indication of the linked account and the indication of the approval of the transaction request by the linked account. The encryption circuitry 214 may encrypt the first data structure (e.g., data that may form the first payment token) to produce an encrypted data for transfer to the client device 106. In some embodiments, the encryption may be performed using a key and cryptographic method such that the data may be decrypted by the client device 106 and subsequently re-encrypted and transmitted to a merchant device of the merchant service provider 110. In some embodiments, the encryption may be performed using a key and cryptographic method such that the data may be encapsulated or merely received and re-transmitted by the client device 106, where the encrypted data may be decrypted by a merchant device of the merchant service provider 110.

As shown by operation 640, the apparatus 200 includes means, such as transaction circuitry 208, or the like, for generating a first payment token comprising an indication of the linked account and the indication of the approval of the transaction request by the linked account. As mentioned previously, the payment token may comprise the first data structure, which may be encrypted to form the first payment token. The first payment token may include information required by a merchant device of the merchant service provider 110 to complete a transaction, such as an indication of the linked account and/or any other transaction details needed for transaction settlement.

As shown by operation 645, the apparatus 200 includes means, such as communications hardware 206, or the like, for transmitting, by the communication hardware, the first payment token to the first device (e.g., client device 106). The communications hardware 206 may transmit the payment token to the client device 106 in response to a request received during, for example, operation 610. The communications hardware 206 may utilize any standard encryption or other security measures (in addition to or in place of any encryption or signing during other operations such as operation 635), and/or may sign the first payment token to provide assurance that the first payment token is produced by a trusted entity. For example, the communications hardware 206 may provide the payment token through the interface of a web browser in the context of online shopping, and/or may use a mobile application to transfer the first payment token seamlessly, without additional interaction required by a user of the client device 106.

As shown by operation 650, the apparatus 200 includes means, such as communications hardware 206, settlement circuitry 212, or the like, for receiving a set of transaction data from the merchant service provider 110. It will be understood that in some embodiments, a dedicated server, cloud service, or other device or set of devices may be dedicated to settling transactions, and accordingly this service may receive the set of transaction data from the merchant service provider. The settlement service provider (device or service) may route the transaction data to the apparatus 200 to perform operation 655 and operation 660. In any case, the communications hardware 206 may receive the set of transaction data, which may include, for example, the cash value of the transaction and various transaction details from the transaction (a transaction date and timestamp, identifying information of the client device 106, identifying information for the first account and/or the linked account, and/or the like).

As shown by operation 655, the apparatus 200 includes means, such as transaction circuitry 208, or the like, for verifying a match between the set of transaction data and the transaction request. The transaction circuitry may verify data from the set of transaction data to ensure a match with the data collected during operation 615. For example, a timestamp may be compared to ensure the first payment token was not harvested and re-used later for a fraudulent purpose. The transaction circuitry 208 may also compare hardware device identifiers collected at the different stages of the transaction, information identifying the accounts and transaction methods used, and/or any other available information that may be checked to verify that the approved transaction is the same as the transaction received and forwarded by the merchant service provider 110.

As shown by operation 660, the apparatus 200 includes means, such as communications hardware 206, or the like, for in an instance in which the match is verified, transmitting an indication of success of the transaction. The indication of success may be transmitted to the client device 106 and/or the client device 108 and may use an API to cause the indication to be displayed using a mobile application of the client devices. For example, a notification may appear as a push notification on the client device 106 and client device 108 and/or a confirmation message may be inserted into a chat session involving users of the accounts associated with user device 106 and user device 108.

As shown by operation 665, the apparatus 200 includes means, such as, settlement circuitry 212, or the like, for causing, by settlement circuitry, settlement of the transaction. As noted previously, settlement may be performed by a separate settlement service (and/or dedicated device) or may be performed by settlement circuitry 212 of the apparatus 200. The settlement may be performed after noting one or more details of the transaction (including at least the value of the transaction and the parties involved). The settlement may be performed in aggregate with other transactions, and therefore may be combined additional transaction details before an actual exchange of funds may occur. Accordingly, the settlement circuitry 212 may use any established methods known in the art to settle the transactions described herein transparently, using methods available for any traditional transaction.

### Example System Interaction

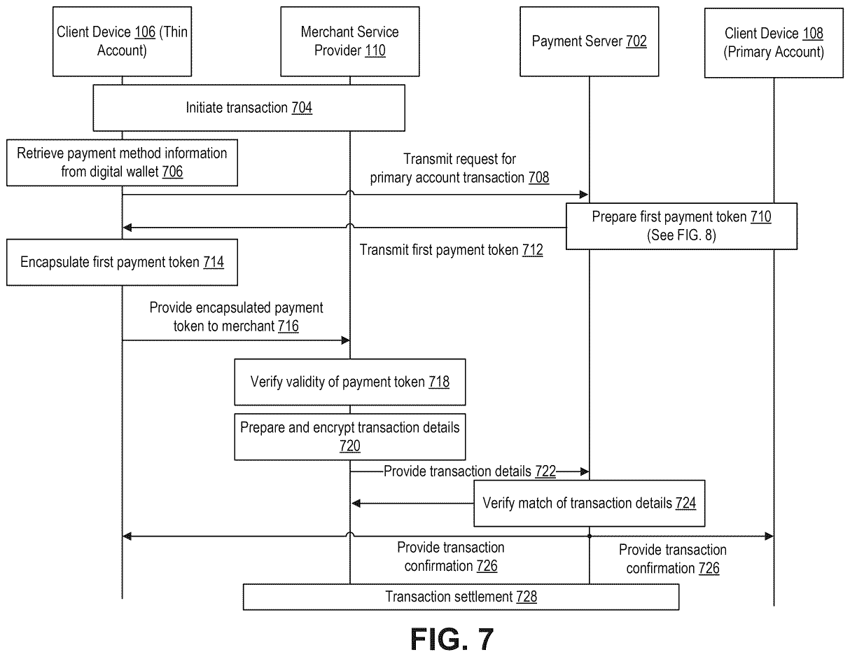

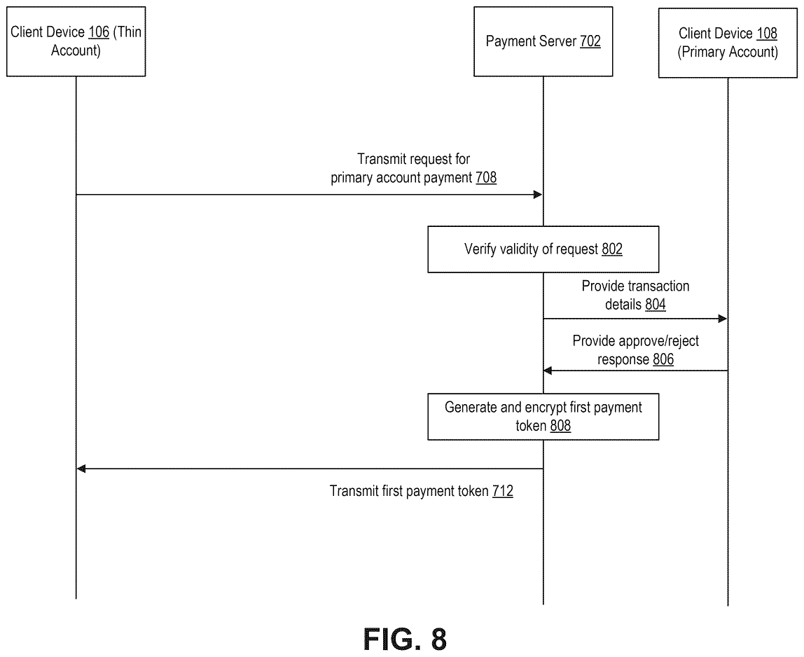

FIGS. 7-8 show swim lane diagrams illustrating example operations (e.g., as described above in connection with FIGS. 4-6) performed by components of the environment depicted in FIG. 1 to produce various benefits of the implementations described herein. The operations shown in the swim lane diagram performed by client device 106 are shown along the line extending from the box labeled “client device 106 (thin account),” operations performed by a device associated with merchant service provider 110 are shown along the line extending from the box labeled “merchant service provider 110,” operations performed by a payment server (e.g., associated with or embodying a linked account payment system 102) are shown along the line extending from the box labeled “payment server 702,” and operations performed by a client device 108 are shown along the line extending from the box labeled “client device 108 (primary account).” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 7-8.

At operation 704, the client device 106 and the merchant service provider 110 may initiate a transaction. At operation 706, the client device 106 may retrieve transaction information from a digital wallet. At operation 708, the client device 106 may transmit a request for transaction by the primary account to the payment server 702. At operation 710, the payment server 702 and client device 108 may prepare a first payment token (as discussed in greater detail in connection with FIG. 8). At operation 712, the payment server 702 may transmit a first payment token to the client device 106. At operation 714, the client device 106 may encapsulate (or otherwise modify) the first payment token (to produce an encapsulated payment token). At operation 716, the client device 106 may provide the encapsulated payment token to a merchant service provider 110. At operation 718, the merchant service provider may verify the validity of the payment token. At operation 720, the merchant service provider may prepare and encrypt transaction details to be communicated to the payment server 702, for verifying the transaction and seeking settlement of the transaction. At operation 722, the merchant service provider may provide transaction details to the payment server 702. At operation 724, the payment server 702 may verify a match of transaction details and provide confirmation to the merchant service provider 110. At operation 726, the payment server 702 may provide confirmation of the transaction to the client device 106 and the client device 108. At operation 728, the payment server 702 may perform transaction settlement with the merchant service provider 110.

Turning to FIG. 8, operation 710 is expanded to show further detail. Operation 708 and operation 712 are included from FIG. 7 for context. At operation 802, the payment server 702 may verify the validity of the request for primary account transaction. At operation 804, the payment server 702 may provide transaction details to the client device 108. The client device 108 may prompt the user to approve or reject the transaction, and at operation 806, the client device 108 may provide a response including indication of approving or rejecting the transaction to the payment server 702. At operation 808, the payment server 702 may generate and encrypt the first payment token.

In some embodiments, some of the operations described above in connection with FIGS. 4-8 may be modified or further amplified. Furthermore, in some embodiments, additional optional operations may be included. Modifications, amplifications, or additions to the operations above may be performed in any order and in any combination.

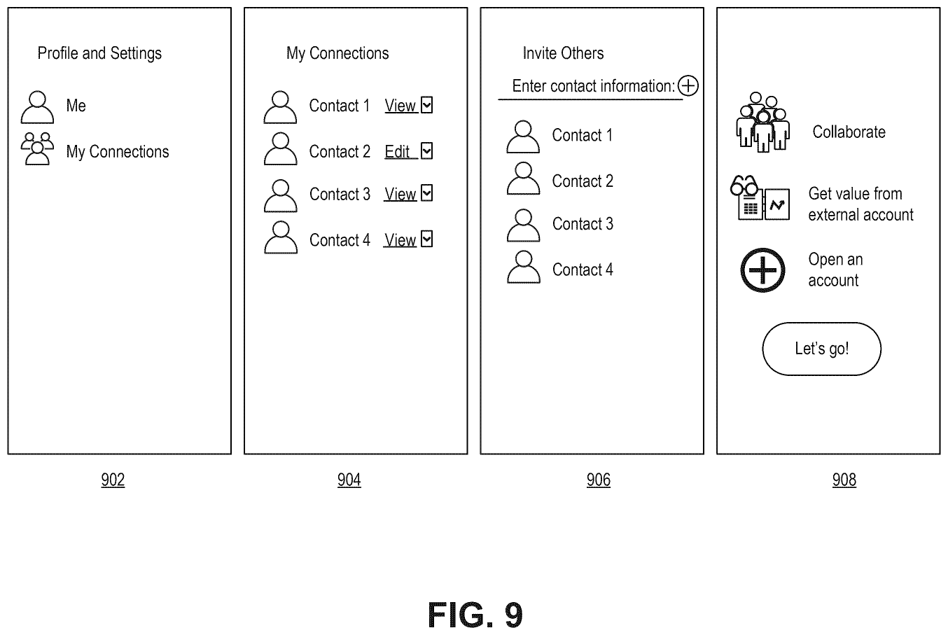

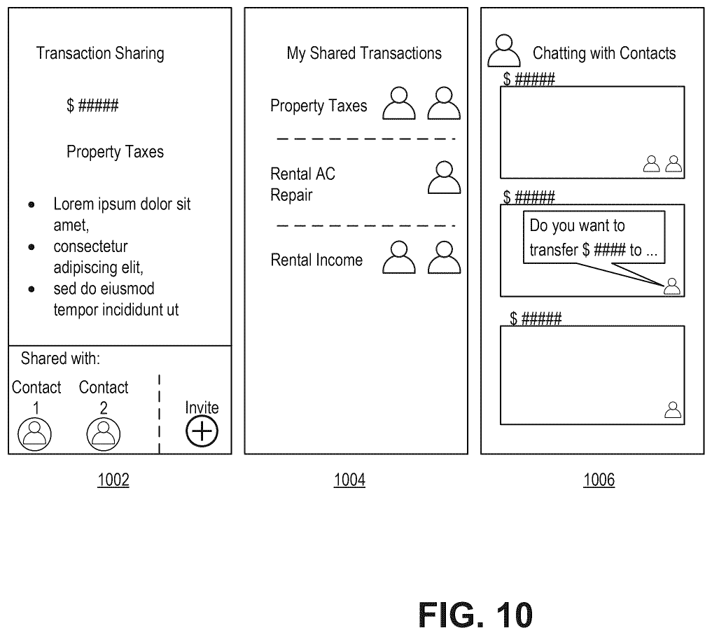

Turning to FIGS. 9-10, several examples of a graphical user interface (GUI) are provided that illustrates a mobile application interface for performing a transaction with linked assets. As noted previously, a user may interact with the linked account payment system 102 by a mobile application of the client device 106 and/or client device 108. In such an embodiment, the GUI shown in FIG. 9 may be displayed to a user by the apparatus 300.

View 902 illustrates a high-level menu for selection options for sharing financial information with users of other accounts. View 902 includes a “profile and settings” page with options for personal options of the user and settings related to the user's connected accounts.

View 904 illustrates the “my connections” view from “profile and settings” menu shown previously. In this view, a list of contacts (named “contact 1” through “contact 4” for the purposes of this example) are listed, with options to interact with each connection detail including “view” and “edit”.

View 906 illustrates a “invite others” menu in the connections GUI. The view shows existing linked contacts (“contact 1” through “contact 4”) and includes a field for adding new contact information (e.g., an email address, phone number, full name, etc.).

View 908 illustrates a menu of actions that may be taken with respect to a linked account. Options are presented to collaborate with a linked account, get value from an external account, and open a new account. A button at the bottom of the interface may be used to accept the selected option.

Turning to FIG. 10, view 1002 illustrates a view for transaction sharing with a linked account. A field may display a monetary value and a short text description of the transaction (“property taxes”). Additional details, shown in the example as filler text, may provide further context such as notes, description of a vendor or payee, and/or the like. A pane at the bottom of the view shows sharing information, and indicates sharing with “contact 1” and “contact 2” by showing profile pictures and contact names. A button labeled “invite” on the right-hand side of the bottom pane may be pressed to add additional contacts to the collaborative view.

View 1004 illustrates a “my shared transactions” interface. A list of transactions is shown (in this example, “property taxes”, “rental AC repair”, and “rental income”), and each transaction has a compact illustration of the sharing status, which depicts the profile pictures of contacts with whom the transaction is shared.

View 1006 illustrates an interface for chatting with contacts. The three chat windows shown correspond go different shared transactions, and a monetary value is indicated in connection with each chat interface. In the corner of each interface is a compact representation of the participants in the chat. An example chat message is shown in the second interface, where participants can suggest shared expenses and/or request funds for paying using linked accounts.

### Conclusion

As described above, example embodiments provide methods and apparatuses that enable financial transactions using assets of linked accounts. By integrating social features into the world of financial services, example embodiments improve the user experience, improve user retention and outreach, and provide an inclusive and engaging experience for customers.

As these examples all illustrate, example embodiments contemplated herein provide technical solutions that solve real-world problems faced in the field of digital communications.

While technologies exist generally for social networking and communication in the context of social networks, techniques to integrate social features into financial services are still needed, as demonstrated by a lack of adoption of such features in the industry. Example embodiments disclosed herein overcome limitations preventing the use of social networking features in banking and financial services mobile applications by providing added value to users through offering convenient payment methods and collaborative financial features that mirror the way finances are managed in the real world. Accordingly, example embodiments described herein represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1.-20. (canceled)

21. A method for authorizing funds for a linked account to perform a transaction, the method comprising:
generating, by account security circuitry, a first account associated with a first device, wherein the first account comprises an indication of the linked account, wherein the first account is a thin account without access to deposited funds or a line of credit;
receiving, by communication hardware and from the first device associated with the first account, a transaction request based on the transaction, the transaction request comprising a cash value, an indication of a merchant service provider, a transaction detail, and an indication of the linked account;
verifying, by the account security circuitry, validity of the transaction request based on the first account;
verifying, by the account security circuitry, a link between the first account and the linked account, wherein the link provides authorization for the first account to request the funds from the linked account;
transmitting, by the communication hardware, a notification comprising the cash value, the indication of the merchant service provider, and the transaction detail to a second device associated with the linked account;
receiving, by the communication hardware, a response to the notification, the response comprising an indication of approval of the transaction request;
generating, by transaction circuitry, a first payment token comprising an indication of the linked account and the indication of the approval of the transaction request by the linked account;
transmitting, by the communication hardware, the first payment token to the first device;
receiving, by the communication hardware and from the merchant service provider, a set of transaction data;
verifying, by the transaction circuitry, a match between the set of transaction data and the transaction request;
in an instance in which the match is verified, transmitting, by the communication hardware, an indication of success of the transaction; and
causing, by settlement circuitry, settlement of the transaction.

22. The method of claim 21, wherein causing the settlement of the transaction comprises:
causing, by the settlement circuitry, release of the funds from the linked account equal to the cash value.

23. The method of claim 21, wherein the transaction detail is a text description of a reason for the transaction.

24. The method of claim 21, wherein the transaction request is received via an application programming interface (API), wherein transmitting the notification to the second device causes display of a graphical representation of the transaction request on a chat UI.

25. The method of claim 21, wherein the first payment token comprises a payment card number.

26. The method of claim 21, wherein the first payment token is a data object, wherein the first payment token is encrypted, wherein generating the first payment token comprises:
encrypting, by encryption circuitry, a first data structure comprising the indication of the linked account and the indication of the approval of the transaction request by the linked account.

27. The method of claim 21, wherein the first payment token comprises a timestamp, wherein verifying the match between the set of transaction data and the transaction request comprises comparing the timestamp to a transaction time reported by the merchant service provider.

28. An apparatus for authorizing funds for a linked account to perform a transaction, wherein the apparatus is associated with the linked account, the apparatus comprising:
account security circuitry configured to:
generate a first account associated with a first device, wherein the first account comprises an indication of the linked account, wherein the first account is a thin account without access to deposited funds or a line of credit;
communications hardware configured to:
receive, from the first device associated with the first account, a transaction request based on the transaction, the transaction request comprising a cash value, an indication of a merchant service provider, a transaction detail, and an indication of the linked account;
wherein the account security circuitry is further configured to:
verify validity of the transaction request based on the first account, and
verify a link between the first account and the linked account, wherein the link provides authorization for the first account to request the funds from the linked account,
wherein the communications hardware is further configured to:
transmit a notification comprising the cash value, the indication of the merchant service provider, and the transaction detail to a second device associated with the linked account, and
receive a response to the notification, the response comprising an indication of approval of the transaction request;
transaction circuitry configured to:
generate a first payment token comprising an indication of the linked account and the indication of the approval of the transaction request by the linked account,
wherein the communications hardware is further configured to:
transmit the first payment token to the first device, and
receive, from the merchant service provider, a set of transaction data,
wherein the transaction circuitry is further configured to:
verify a match between the set of transaction data and the transaction request,
wherein the communications hardware is further configured to:
in an instance in which the match is verified, transmit an indication of success of the transaction; and
settlement circuitry configured to:
cause settlement of the transaction.

29. The apparatus of claim 28, wherein the settlement circuitry is configured so that causing the settlement of the transaction comprises:
causing release of the funds from the linked account equal to the cash value.

30. The apparatus of claim 28, wherein the transaction detail is a text description of a reason for the transaction.

31. The apparatus of claim 28, wherein the transaction request is received via an application programming interface (API), wherein transmitting the notification to the second device causes display of a graphical representation of the transaction request on a chat UI.

32. The apparatus of claim 28, wherein the first payment token comprises a payment card number.

33. The apparatus of claim 28, wherein the first payment token is a data object, wherein the first payment token is encrypted, the apparatus further comprising encryption circuitry configured so that generating the first payment token comprises:
encrypting a first data structure comprising the indication of the linked account and the indication of the approval of the transaction request by the linked account.

34. The apparatus of claim 28, wherein the first payment token comprises a timestamp, wherein verifying the match between the set of transaction data and the transaction request comprises comparing the timestamp to a transaction time reported by the merchant service provider.

35. A computer program product for authorizing funds for a linked account to perform a transaction, the computer program product comprising at least one non-transitory computer-readable storage medium storing program instructions that, when executed, cause a system associated with the linked account to:
generate a first account associated with a first device, wherein the first account comprises an indication of the linked account, wherein the first account is a thin account without access to deposited funds or a line of credit;
receive, from the first device associated with the first account, a transaction request based on the transaction, the transaction request comprising a cash value, an indication of a merchant service provider, a transaction detail, and an indication of the linked account;
verify validity of the transaction request based on the first account;
verify a link between the first account and the linked account, wherein the link provides authorization for the first account to request the funds from the linked account;
transmit a notification comprising the cash value, the indication of the merchant service provider, and the transaction detail to a second device associated with the linked account;
receive a response to the notification, the response comprising an indication of approval of the transaction request;
generate a first payment token comprising an indication of the linked account and the indication of the approval of the transaction request by the linked account;
transmit the first payment token to the first device;
receive, from the merchant service provider, a set of transaction data;
verify a match between the set of transaction data and the transaction request;
in an instance in which the match is verified, transmit an indication of success of the transaction; and
causing settlement of the transaction.

36. The computer program product of claim 35, wherein causing the settlement of the transaction comprises:
causing release of the funds from the linked account equal to the cash value.

37. The computer program product of claim 35, wherein the transaction detail is a text description of a reason for the transaction.

38. The computer program product of claim 35, wherein the transaction request is received via an application programming interface (API), wherein transmitting the notification to the second device causes display of a graphical representation of the transaction request on a chat UI.

39. The computer program product of claim 35, wherein the first payment token comprises a payment card number.

40. The computer program product of claim 35, wherein the first payment token is a data object, wherein the first payment token is encrypted, wherein generating the first payment token comprises:
encrypting a first data structure comprising the indication of the linked account and the indication of the approval of the transaction request by the linked account.
